(19) United States
(12) Patent Application Publication
(10) Pub. No.: US 2006/0168525 A1
(43) Pub. Date: Jul. 27, 2006

(54) Conference assistance system

(75) Inventors: Yaw-Huei Tsai, Sijhih City (TW); Ya-Cheng Tzeng, Taoyuan County 326 (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/328,167

(22) Filed: Jan. 10, 2006

(30) Foreign Application Priority Data
Jan. 13, 2005 (TW) 094101054

(51) Int. Cl. G06F 17/00; G06F 3/00; G06F 9/00

(52) U.S. Cl. 715/730

(57) ABSTRACT

A conference assistance unit includes a twin image screen and a writing board. In this case, the writing board is disposed at one side of the twin image screen.

### BACKGROUND OF THE INVENTION

1. Field of Invention

The invention relates to an assistance system and, in particular, to a conference assistance system.

2. Related Art

Since the information industry is rapidly developed, people have strong demands on the information image displaying. In the occasion such as a research conference or a product conference, a conference assistance system is necessary for recording the explanations and information that the speaker or sponsor writes on a white board.

As shown in FIG. 1, a conventional conference assistance system 1 mainly includes a white board 11, an optical scanning device 12, and a printing device 13.

During the conference, the speaker usually writes the outlines, the explanatory notes of the key points on the white board 11 with a specific fast-dried oil marker, and then uses an eraser to erase the written words.

The optical scanning device 12 and the printing device 13 are installed on one side of the white board 11. As the white board 11 is fully filled with the written words or the speech is ended, a printing button 14 is pressed. Then, the white board 11 starts to rotate, and the words on the white board 11 can be scanned by the optical scanning device 12. Finally, the printing device 13 prints the scanned information on the white board 11. Accordingly, the words written on the white board 11 can be exactly recorded.

In addition to write words on the white board 11, some users take the white board 11 as a projecting screen. In detailed, the projected image is displayed on the white board 11 for presenting plentiful briefing contents. However, the view angle and contrast of the white board 11 are unsuitable, and the conference assistance system 1 cannot display images on both sides of the white board 11 simultaneously. Thus, when the white board 11 is positioned in the audiences, not all of they can get the images displayed on the white board 11. If more conference assistance systems 1 are provided to show the images on two sides of the white board 11, only the audiences at one side of the white board 11 can see the explanatory notes made by the speaker. Therefore, it is desired to provide a conference assistance system that has clear projecting images on both sides of the white board and can make the audiences at both sides of the white board to see the explanatory notes on it simultaneously.

Therefore, it is an important subject of the invention to provide a conference assistance system which can display images on both sides of the white board.

### SUMMARY OF THE INVENTION

In view of the foregoing, the invention is to provide a conference assistance system that can display images on both sides of a white board.

To achieve the above, a conference assistance system of the invention includes a twin image screen and a writing board. In the invention, the writing board is disposed at one side of the twin image screen.

As mentioned above, the conference assistance system of the invention can make the audiences at two sides of the screen to see the clear images simultaneously. Compared with the prior art, the conference assistance system of the invention includes the twin image screen and the writing board. With the conference assistance system of the invention, the audiences at two sides of the twin image screen can see the clear images simultaneously. Besides, when the speaker writes the explanatory notes on the writing board, the audiences at two sides of the twin image screen can also see the explanatory notes simultaneously. Therefore, more audiences can get the conference contents with only one conference assistance system of the invention, so that the cost for more screens can be saved. In addition, since the twin image screen has larger view angle, the invention can provide clearer image with better contrast than that of the conventional projecting screen, the white board. Accordingly, the invention can greatly enhance the performance of the conference assistance system.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional conference assistance system;

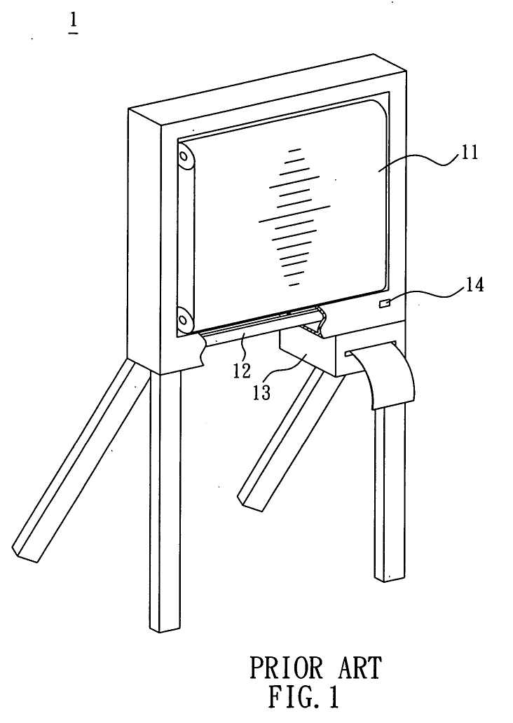

FIG. 2 is an enlarged schematic diagram showing a conference assistance system according to a preferred embodiment of the invention; and

FIG. 3, is another schematic diagram of the conference assistance system according to the embodiment of the invention.

### DETAILED DESCRIPTION OF THE INVENTION

The present invention will be apparent from the following detailed description, which proceeds with reference to the accompanying drawings, wherein the same references relate to the same elements.

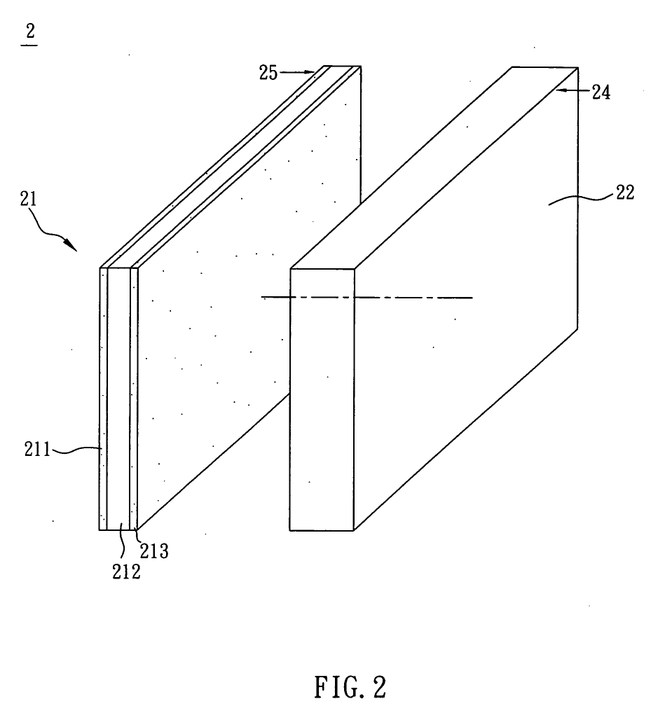

With reference to FIG. 2, a conference assistance system 2 according to a preferred embodiment of the invention includes a twin image screen 21 and a writing board 22.

The twin image screen 21 includes a first diffuser 211, a transparent substrate 212 and a second diffuser 213. In this embodiment, the first diffuser 211 is disposed at one side of the transparent substrate 212, and the second diffuser 213 is disposed at another side of the transparent substrate 212.

The first diffuser 211 is located at one side of the transparent substrate 212. In the embodiment, the first diffuser 211 can be formed by a scrape coating process or a spin coating process. In more details, a liquid row material of the first diffuser 211 is coated on one side of the transparent substrate 212 by a scrape coating process or a spin coating process, and the transparent substrate 212 is processed with a curing process so as to form the first diffuser 211.

In addition, the first diffuser 211 is composed of a first diffuser powder and a first resin. In this case, the first resin is made of a styrene-methyl methacrylate (MS). In the current embodiment, the first diffuser powder has a particle size approximately ranged from 0.5 μm to 20 μm and a refraction index approximately ranged from 1.4 to 1.7. The first diffuser powder can be made of polucarbonate, polyacrylate, polystyrene, or their mixtures.

The transparent substrate 212 is made of polyethylene terephthalate (PET). Besides, the transparent substrate 212 is flexible and has a thickness approximately ranged from 100 μm to 200 μm.

In the embodiment, the second diffuser 213 is composed of a second diffuser powder and a second resin. In this case, the second resin is made of a styrene-methyl methacrylate (MS). The second diffuser powder has a particle size approximately ranged from 0.5 μm to 20 μm and a refraction index approximately ranged from 1.4 to 1.7. The second diffuser powder can be made of polucarbonate, polyacrylate, polystyrene, or their mixtures.

In the embodiment, the second diffuser powder may be the same as the first diffuser powder. They may be respectively added into the second diffuser 213 and the first diffuser 211 in different ratios so as to adjust the brightness of two surfaces of the twin image screen 21 It is preferred to adjust the two surfaces of the twin image screen 21 to have the same brightness. In this case, the displayed image is clear, high contrast, and good color saturation. Of course, the first diffuser powder and the second diffuser powder may be different diffuser powders.

The writing board 22 is disposed at one side of the twin image screen 21. In this case, the twin image screen 21 is thinner, and the writing board 22 can be used to support it. The writing board 22 can be made of polyacrylate or glass. In the present embodiment, the writing board 22 is positioned next to the second diffuser 213. An adhesive can be used to bond the twin image screen 21 to the writing board 22. Alternatively, two writing boards 22 may be used to hold the twin image screen 21 therebetween. Besides, a pressure sensitive adhesion may be added into the first diffuser 211 or the second diffuser 213, so that the writing board 22 can directly bonded to the first diffuser 211 or the second diffuser 213. Therefore, during a speech, the speaker can write words, such as the explanatory notes, on the surface of the writing board 22 with an oil marker or a specific marker and can erase the wrong words, which is helpful in understanding the conference contents and progressing of the conference.

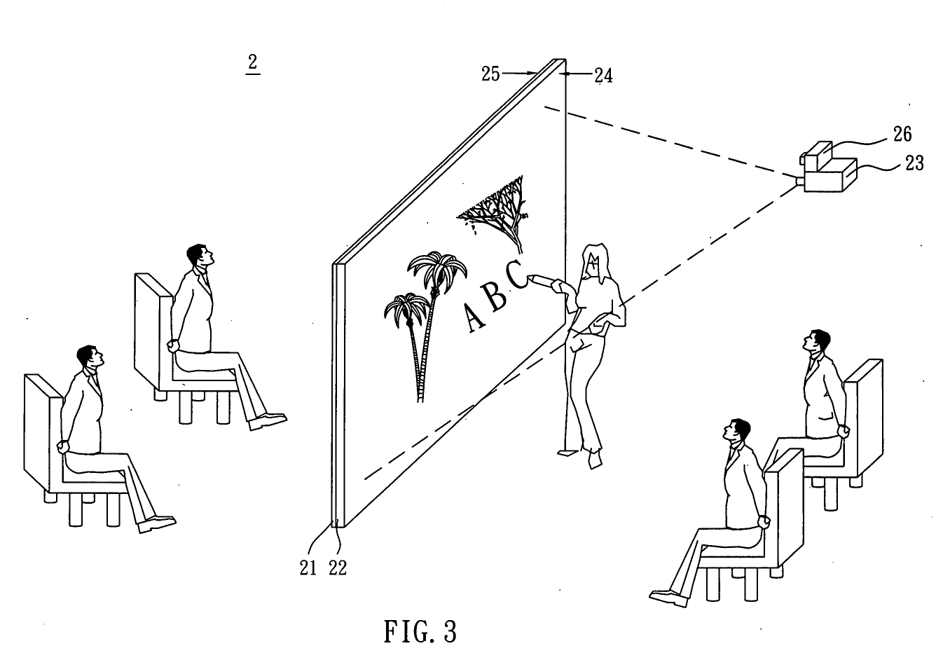

With reference to FIG. 3, the conference assistance system 2 may further include a projector 23, which is disposed opposite to the twin image screen 21 for projecting an image on the twin image screen 21. In the embodiment, the projector 23 is a front projector.

Please refer to FIGS. 2 and 3. When an image is projected from the projector 23 to a first side surface 24 of the twin image screen 21, a part of the projected light is reflected by the first diffuser powder of the first diffuser 211 and is then seen by the audiences opposite to the first side surface 24. The rest part of the projected light is refracted, penetrates the transparent substrate 212, and then reaches the second diffuser 213. In this case, a part of the light reaching the second diffuser 213 is reflected by the second diffuser 213 to the first diffuser 211, and the rest part of the light reaching the second diffuser 213 is refracted and is then seen by the audiences opposite to the second side surface 25 of the twin image screen 21. Since the projected light is reflected and refracted by the first diffuser 211 and the second diffuser 213, the twin image screen 21 can have larger view angle.

Referring to FIG. 3, the conference assistance system 2 of the embodiment may further include a camera 26, which is disposed adjacent to the projector 23 for recording information, such as an image and words, shown on the twin image screen 21 and the writing board 22. By using the camera 26 to shoot the image shown on the twin image screen 21 and the explanatory notes written on the writing board 22, the details of the conference can be exactly recorded.

Since the writing board 22 is transparent and the twin image screen 21 is translucent, the image projected from the projector 23 to the twin image screen 21 can be clearly viewed by the audiences at two sides of the twin image screen 21. Of course, the words written on the writing board 22 can be seen by the audiences at two sides of the twin image screen 21.

In summary, the conference assistance system of the invention includes the twin image screen and the writing board. With the conference assistance system of the invention, the audiences at two sides of the twin image screen can see the clear images simultaneously. Besides, when the speaker writes the explanatory notes on the writing board, the audiences at two sides of the twin image screen can also see the explanatory notes simultaneously. Therefore, more audiences can get the conference contents with only one conference assistance system of the invention, so that the cost for more screens can be saved. In addition, since the twin image screen has larger view angle, the invention can provide clearer image with better contrast than that of the conventional projecting screen, the white board. Accordingly, the invention can greatly enhance the performance of the conference assistance system.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A conference assistance unit, comprising:
a twin image screen; and
a writing board disposed at one side of the twin image screen.

2. The conference assistance unit of claim 1, wherein the twin image screen comprises a first diffuser, a transparent substrate, and a second diffuser, the first diffuser is disposed at one side of the transparent substrate, and the second diffuser is disposed at another side of the transparent substrate.

3. The conference assistance unit of claim 2, wherein the first diffuser is composed of a first diffuser powder and a first resin.

4. The conference assistance unit of claim 3, wherein the first diffuser powder has a particle size ranged from 0.51 μm to 20 μm.

5. The conference assistance unit of claim 3, wherein the first diffuser powder has a refraction index ranged from 1.4 to 1.7.

6. The conference assistance unit of claim 3, wherein the first diffuser powder is made of polucarbonate, polyacrylate, polystyrene, or their mixtures.

7. The conference assistance unit of claim 3, wherein the first resin is made of a styrene-methyl methacrylate (MS).

8. The conference assistance unit of claim 2, wherein the transparent substrate is made of polyethylene terephthalate (PET) and has a thickness ranged from 100 μm to 200 μm.

9. The conference assistance unit of claim 2, wherein the second diffuser is composed of a second diffuser powder and a second resin.

10. The conference assistance unit of claim 9, wherein the second diffuser powder has a particle size ranged from 0.5 μm to 20 μm.

11. The conference assistance unit of claim 9, wherein the second diffuser powder has a refraction index ranged from 1.4 to 1.7.

12. The conference assistance unit of claim 9, wherein the second diffuser powder is made of polucarbonate, polyacrylate, polystyrene, or their mixtures.

13. The conference assistance unit of claim 9, wherein the second resin is made of a styrene-methyl methacrylate (MS).

14. The conference assistance unit of claim 2, wherein the first diffuser is composed of a first diffuser powder, the second diffuser is composed of a second diffuser powder, and the first diffuser powder and the second diffuser powder are different.

15. The conference assistance unit of claim 1, wherein the writing board is made of polyacrlate or glass.

16. The conference assistance unit of claim 1, further comprising:
a projector, which is disposed opposite to the twin image screen for projecting an image on the twin image screen.

17. The conference assistance unit of claim 16, wherein the projector is a front projector.

18. The conference assistance unit of claim 1, further comprising:
a camera, which is disposed adjacent to the projector for recording information shown on the twin image screen and the writing board.
